(19) United States
(12) Patent Application Publication
(10) Pub. No.: US 2022/0405844 A1
(43) Pub. Date: Dec. 22, 2022

(54) METHOD AND SYSTEM FOR PEER-TO-PEER ELECTRICITY TRADING BASED ON DOUBLE-LAYER BLOCKCHAIN

(71) Applicant: Hefei University of Technology, Hefei (CN)

(72) Inventors: Kaile ZHOU, Hefei (CN); Hengheng XING, Hefei (CN); Dingding HU, Hefei (CN); Zenghui ZHANG, Hefei (CN)

(21) Appl. No.: 17/893,405

(22) Filed: Aug. 23, 2022

(30) Foreign Application Priority Data
Dec. 15, 2021 (CN) 202111532227.7

(51) Int. Cl. G06Q 40/04; H02J 3/38

(52) U.S. Cl. CPC G06Q 40/04; H02J 3/381; G06Q 50/06

(57) ABSTRACT

A method, a system, a storage medium and an electronic device for peer-to-peer electricity trading based on a double-layer blockchain. Provided herein relates to electricity trading. This application includes a bulk grid blockchain and a plurality of microgrid blockchains and puts forward a double-layer blockchain technology. The energy consumption plan or the energy supply plan of the trading subjects shall preferentially perform a first power dispatching-matching and a second power dispatching-matching on the microgrid blockchain, and the unsatisfied energy consumption plan or the remaining energy supply plan is uploaded to large power grid blockchain for a third power dispatching-matching.

### CROSS-REFERENCE TO RELATED APPLICATIONS

This application claims the benefit of priority from Chinese Patent Application No. 202111532227.7, filed on Dec. 15, 2021. The content of the aforementioned application, including any intervening amendments thereto, is incorporated herein by reference in its entirety.

### TECHNICAL FIELD

This application relates to electricity trading, and more particularly to a method, a system, a storage medium and an electronic device for peer-to-peer electricity trading based on a double-layer blockchain.

### BACKGROUND

As the distributed power sources, energy storage, power-to-gas and other devices have developed rapidly, traditional electric power consumers have gradually transformed into prosumers who can both generate power and consume power. Due to a large number of participants in the electricity trading system, the high complexity of the trading system, the ambiguity of the identities of the participants, the diversity and the distributed characteristics of resources, the traditional power operation using a centralized structure for management is presented with many challenges: (1) the inevitable trust problem exists between the trading center and the traders, and the fairness, transparency and effectiveness of the trading cannot be guaranteed; (2) there is a large number of trading subjects and the scale of the trading is small, such that it is difficult for the trading subjects to freely negotiate and actively coordinate among each other, increasing the operation cost; (3) the centralized database enhances the risk of data tampering, which directly threatens the security of trading data and the interests of trading parties.

The blockchain technology has the characteristics of decentralization, openness and transparency and tamper resistance. The blockchain saves data in each node in the network, and the data is jointly maintained by all nodes. It is effective for the system for peer-to-peer electricity trading based on the blockchain to conquer the challenges brought by the centralized structure in the traditional power operation.

However, with the integration of a large number of prosumers into the blockchain, the number of blockchain nodes has increased sharply, such that the security and stability of the system are presented with the new challenges: (1) each blockchain node is required to store not only trading information, but also physical information, such that the information capacity is under great pressure; (2) the high frequency of the electricity trading between the blockchain nodes and the excessive trading flow are prone to cause the threshold-crossing of the power flow, which challenges the security of the system; (3) a mass of calculations and time are needed to solve the sharply increasing number of trading data, which is difficult satisfy the requirement of the dispatching in real time.

### SUMMARY

An objective of this application is to provide a method, a system, a storage medium and an electronic device for peer-to-peer electricity trading based on a double-layer blockchain, which alleviates the pressure on the information storage capacity, threshold-crossing of power flow, and calculation demand resulted from the excessive blockchain nodes.

In order to achieve those objectives, technical solutions of this application are described as follows.

In a first aspect, this application provides a method for peer-to-peer electricity trading based on a double-layer blockchain; wherein the method is performed through a bulk grid blockchain and a plurality of microgrid blockchains; and the method comprises:

(S1) according to an electricity trading demand of each of a plurality of subjects, obtaining an energy consumption plan and an energy purchase price of each of the plurality of subjects and an energy supply plan and an energy selling price of each of the plurality of subjects; and uploading the energy consumption plan and the energy purchase price of each of the plurality of subjects and the energy supply plan and the energy selling price of each of the plurality of subjects to the endorsement nodes on a microgrid blockchain to which the plurality of subjects belong;

(S2) according to the energy consumption plan and the energy purchase price of each of the plurality of subjects, and the energy supply plan and the energy selling price of each of the plurality of subjects, successively performing a first power dispatching-matching and a second power dispatching-matching between the plurality of subjects by the endorsement nodes on the microgrid blockchain; and uploading an unsatisfied total energy consumption plan and an energy purchase price of each of a plurality of microgrids and a remaining total energy supply plan and an energy selling price of each of the plurality of microgrids to an endorsement node on the bulk grid blockchain;

(S3) according to the unsatisfied total energy consumption plan and the energy purchase price of each of the plurality of microgrids and the remaining total energy supply plan and the energy selling price of each of the plurality of microgrids, introducing a centralized power system, and performing a third power dispatching-matching between the plurality of microgrids by the endorsement node on the bulk grid blockchain;

(S4) based on information of the first power dispatching-matching, the second power dispatching-matching and the third power dispatching-matching, forming a trading contract and performing verification; after passing the verification, sending the information of the first power dispatching-matching, the second power dispatching-matching and the third power dispatching-matching to a sorting node of a microgrid blockchain corresponding to each of two trading subject parties and update the microgrid blockchain corresponding to each of two trading subject parties; and

(S5) based on the trading contract, performing an electricity trading; and recording actual trading data on the microgrid blockchain corresponding to each of two trading subject parties.

In an embodiment, the step (S2) further comprises:

(S21) according to the energy consumption plan and the energy purchase price of each of the plurality of subjects, and the energy supply plan and the energy selling price of each of the plurality of subjects, performing the first power dispatching-matching by a first endorsement node; wherein the endorsement nodes on the microgrid blockchain comprises the first endorsement node, a second endorsement node and a third endorsement node;

when e_{c,β}≥e_{p,α}, if

$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$

performing the first power dispatching-matching between an energy supply subject α and an energy consumption subject β followed by proceeding to step (S4); uploading a first unsatisfied energy consumption plan to the second endorsement node; otherwise, according to an objective function of preset quoted price information of the energy supply and consumption subject, obtaining a corresponding optimized trading price; based on the corresponding optimized trading price, performing the first power dispatching-matching between the energy supply subject α and the energy consumption subject β followed by proceeding to step (S4); and uploading the first unsatisfied energy consumption plan to the second endorsement node;

when e_{c,β}<e_{p,α}, if

$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$

performing the first power dispatching-matching between the energy supply subject α and the energy consumption subject β followed by proceeding to step (S4); uploading a first remaining energy supply plan to the second endorsement node; otherwise, according to the objective function of the preset quoted price information of the energy supply and consumption subject, obtaining the corresponding optimized trading price; based on the corresponding optimized trading price, performing the first power dispatching-matching between the energy supply subject α and the energy consumption subject β followed by proceeding to step (S4); and uploading the first remaining energy supply plan to the second endorsement node;

wherein e_{p,α} is an energy supply plan of the energy supply subject α; b_{p,α} is an energy selling price of the energy supply subject α; e_{c,β} is an energy consumption plan of the energy consumption subject β; and b_{c,β} is an energy purchase price of the energy purchase subject β;

(S22) according to the first unsatisfied energy consumption plan and the first remaining energy supply plan, performing the second power dispatching-matching between the plurality of subjects by the second endorsement node;

when e,_{c,δ}≥e_{p,χ}, if

$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$

performing the second power dispatching-matching between an energy supply subject χ and an energy consumption subject 8 followed by proceeding to step (S4); uploading a second unsatisfied energy consumption plan to the third endorsement node; otherwise, according to an objective function of preset quoted price information of the energy supply and consumption subject, obtaining a corresponding optimized trading price; based on the corresponding optimized trading price, performing the second power dispatching-matching between the energy supply subject χ and the energy consumption subject δ followed by proceeding to step (S4); and uploading the second unsatisfied energy consumption plan to the third endorsement node;

$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$

when e,_{c,δ}<e_{p,χ}, if performing the second power dispatching-matching between the energy supply subject χ and the energy consumption subject δ followed by proceeding to step (S4); uploading a second remaining energy supply plan to the third endorsement node; otherwise, according to the objective function of the preset quoted price information of the energy supply and consumption subject, obtaining the corresponding optimized trading price; based on the corresponding optimized trading price, performing the second power dispatching-matching between the energy supply subject χ and the energy consumption subject δ followed by proceeding to step (S4); and uploading the second remaining energy supply plan to the third endorsement node;

wherein e_{p,χ} is an energy supply plan of the energy supply subject χ; b_{p,χ} is an energy selling price of the energy supply subject χ; e_{c,δ} is an energy consumption plan of the energy consumption subject δ; and b_{c,δ} is an energy purchase price of the energy purchase subject δ; and

(S23) according to the second unsatisfied energy consumption plan and the energy purchase price and the second remaining energy supply plan and the energy supply price, obtaining the unsatisfied total energy consumption plan and the energy purchase price of each of the plurality of microgrids and the remaining total energy consumption plan and the energy selling price of each of the plurality of microgrids by the third endorsement node; and uploading the unsatisfied total energy consumption plan and the energy purchase price of each of the plurality of microgrids and the remaining total energy consumption plan and the energy selling price of each of the plurality of microgrids to the endorsement node on the bulk grid blockchain.

In an embodiment, the step (S3) further comprises:

when E_{c,ψ}≥E_{p,ξ}, if

$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$

performing the third power dispatching-matching between an energy consumption microgrid ψ and an energy supply microgrid ξ; according to an energy consumption price of an energy consumption subject and an energy selling price of the centralized power system in the second unsatisfied total energy consumption plan, solving an objective function of quoted price information of the energy supply and consumption subject to obtain a corresponding optimized trading price; and according to the corresponding optimized trading price, performing the third power dispatching-matching followed by proceeding to step (S4);

otherwise, according to the objective function of the quoted price information of the energy supply and consumption subject, obtaining the corresponding optimized trading price; performing the third power dispatching-matching between the energy consumption microgrid ψ and the energy supply microgrid according to the optimized trading price; according to the energy consumption price of the energy consumption subject and the energy selling price of the centralized power system in the second unsatisfied total energy consumption plan, solving the objective function of the quoted price information of the energy supply and consumption subject to obtain a corresponding optimized trading price; and according to the corresponding optimized trading price, performing the third power dispatching-matching followed by proceeding to step (S4);

when E_{c,ψ}<E_{p,ξ}, if

$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$

performing the third power dispatching-matching between the energy consumption microgrid ψ and the energy supply microgrid ξ followed by proceeding to step (S4); re-uploading a second remaining total energy supply plan to the endorsement node on the bulk grid blockchain; otherwise, according to the objective function of the quoted price information of the energy supply and consumption subject, obtaining a corresponding optimized trading price; performing the third power dispatching-matching between the energy consumption microgrid ψ and the energy supply microgrid according to the corresponding optimized trading price; re-uploading the second remaining total energy supply plan to the endorsement node on the large power grid blockchain followed by proceeding to step (S4);

wherein E_{c,ψ} is an energy consumption plan of the energy consumption microgrid ψ; B_{c,ψ} is an energy purchase price of the energy consumption microgrid ψ; E_{p,ξ} is an energy supply plan of the energy supply microgrid ξ; B_{p,ξ} is an energy selling price of the energy supply microgrid ξ.

In an embodiment, the objective function of the quoted price information of the energy supply and consumption subject comprises a maximization of a selling power revenue of the energy supply subject, which is expressed as follows:

max u_{p,i}(b_{p,i}, B_{p,-i}, B_{c,j});

and a minimization of a purchase power expenditure of the energy consumption subject, which is expressed as follows:

min u_{c,j}(b_{c,j}, B_{c,-j}, B_{p,i});

wherein u_{p,i} is a utility function of an energy supply subject/microgrid i; b_{p,i} is a quoted price of the energy supply subject/microgrid i;B_{p,-i} is a quoted price of energy supply subjects/microgrids except for the energy supply subject/microgrid i; B_{c,j} indicates all quoted prices of energy consumption subjects/microgrids; u_{c,j} is a utility function of an energy consumption subject/microgrid j; b_{c,j} is a quoted price of the energy consumption subject/microgrid j; B_{c,-j} is a quoted price of energy consumption subjects/microgrids except for the energy consumption subject/microgrid j; and B_{p,i} indicates all quoted prices of energy supply subjects/microgrids;

corresponding constraints comprise:

(1) an upper limit constraint and a lower limit constraint of an output of the energy supply subject/microgrid are expressed as follows:

Q_{p,i}^{min}≤Q_{p,i}≤Q_{p,i}^{max};

wherein Q_{p,i}^{min} is a lower limit of the amount of power supply of the energy supply subject/microgrid; Q_{p,i}^{max} is an upper limit of the amount of power supply of the energy supply subject/microgrid; and Q_{p,i} indicates the amount of power supply of the energy supply subject/microgrid i;

(2) an upper limit constraint and a lower limit constraint of the amount of power purchased by the energy consumption subject/microgrid are expressed as follows:

Q_{c,j}^{min}≤Q_{c,j}≤Q_{c,j}^{max};

wherein Q_{c,j}^{min} is a lower limit of the amount of power purchased by the energy consumption subject/microgrid; Q_{c,j}^{max} is an upper limit of the amount of power purchased by the energy consumption subject/microgrid; and Q_{c,j} indicates the amount of power purchased by an energy consumption subject/microgrid j.

In an embodiment, according to the objective function, obtaining the corresponding optimized trading price based on a strategy of an optimal response;

(1) a dynamic regulation process of the optimal response of a quoted price of the energy consumption subject/microgrid is expressed as follows:

τ_{c,j}(B_{p,i}, B_{c,-j})={b_{c,j}^{*}∈B_{c,j}|u_{c,j}(b_{c,j}^{*}, B_{c,-j}^{*}, B_{p,i}^{*})≤u_{c,j}(b_{c,j}, B_{c,-j}^{*}, B_{p,i}^{*}), ∀b_{c,j}∈B_{c,j}};

wherein τ_{c,j} is a quoted price of the energy consumption subject/microgrid j; b_{c,j}^{*} is a quoted price of the optimal response of the energy consumption subject/microgrid j; B_{c,-j}^{*} is a quoted price of the energy consumption subjects/microgrids except for the energy consumption subject/microgrid j; B_{p,i}^{*} is a quoted price of all the energy supply subjects/microgrids i;

$${r}_{c , j} ( {B}_{p , i} , {B}_{c , - j} ) = arg {min}_{{b}_{c , j} ∈ {B}_{c , j}} {u}_{c , j} ( {b}_{c , j} , {B}_{c , - j}^{*} , {B}_{p , i}^{*} ) ;$$

ensuring a quoted price of all energy supply subjects/microgrids and a quoted price of energy consumption subjects/microgrids except for the energy consumption subject/microgrid j in the market remain unchanged; determining an optimal response of each energy consumption subject/microgrid according to a corresponding quoted price, that is, among all available quoted prices of the energy consumption subject/microgrid j, there is b_{c,j}^{*} to minimum a corresponding utility; and (2) a dynamic regulation process of an optimal response of a quoted price of the energy supply subject/microgrid is expressed as follows:

τ_{p,i}(B_{p,-i}, B_{c,j})={b_{p,i}^{*}∈B_{p,i}|u_{p,i}(b_{p,i}^{*}, B_{p,-i}^{*}, B_{c,j}^{*})≥u_{p,i}(b_{p,i}, B_{p,-i}^{*}, B_{c,j}^{*}), ∀b_{p,i}∈B_{p,i}};

wherein τ_{p,i} is a quoted price of the energy supply subject/microgrid i; b_{p,i}^{*} is a quoted price of the optimal response of the energy supply subject/microgrid i; B_{p,-i}^{*}, is a quoted price of the energy supply subjects/microgrids except for the energy supply subject/microgrid i; B_{c,j}^{*} is a quoted price of all the energy supply subjects/microgrids j;

$${r}_{p , i} ( {B}_{p , - i} , {B}_{c , j} ) = arg {min}_{{b}_{p , i} ∈ {B}_{p , i}} {u}_{p , i} ( {b}_{p , i} , {B}_{p , - i}^{*} , {B}_{c , j}^{*} ) ;$$

ensuring a quoted price of all energy consumption subjects/microgrids and a quoted price of energy supply subjects/microgrids except for the energy supply subject/microgrid i in the market remain unchanged; determining an optimal response of each energy supply subject/microgrid according to a corresponding quoted price, that is, among all available quoted prices of the energy supply subject/microgrid i, there is b_{p,i}^{*} to maximum a corresponding utility.

In an embodiment, step (S5) further comprises:

if the trading contract is not fulfilled or there is a breach of the trading contract during a trading fulfillment, bearing a corresponding breach of contract liability and paying a penalty by a party at fault; if the trading contract is fulfilled successfully, based on actual trading data provided by a smart electricity meter, automatically transferring a trading fee, and recording the actual trading data on the microgrid blockchain corresponding to each of two trading subject parties, so as to complete the electricity trading.

In an embodiment, the method further comprises: before step (S1), assigning an access permission for each of the plurality of subjects to participate in the electricity trading.

In a second aspect, this application provides a system for peer-to-peer electricity trading based on a double-layer blockchain; wherein the system comprises a bulk grid blockchain and a plurality of microgrid blockchains; and the system further comprises:

an acquisition module;

a first matching module;

a second matching module;

a verification module; and

a trading module;

wherein the acquisition module is configured to acquire an energy consumption plan and an energy purchase price of each of a plurality of subjects and an energy supply plan and an energy selling price of each of the plurality of subjects according to an electricity trading demand of each of the plurality of subjects, and upload the energy consumption plan and the energy purchase price of each of the plurality of subjects and the energy supply plan and the energy selling price of each of the plurality of subjects to endorsement nodes on the microgrid blockchain to which the plurality of subjects belong;

the first matching module is configured to successively perform a first power dispatching-matching and a second power dispatching-matching between the plurality of subjects through the endorsement nodes on the microgrid blockchain according to the energy consumption plan and the energy purchase price of each of the plurality of subjects, and the energy supply plan and the energy selling price of each of the plurality of subjects, and upload an unsatisfied total energy consumption plan and an energy purchase price of each of a plurality of microgrids and a remaining total energy supply plan and an energy selling price of each of the plurality of microgrids to an endorsement node on the bulk grid blockchain;

the second matching module is configured to perform a third power dispatching-matching between the plurality of microgrids by the endorsement node on the bulk grid blockchain under a premise that a centralized power system is introduced, according to the unsatisfied total energy consumption plan and the energy purchase price of each of the plurality of microgrids and the remaining total energy supply plan and the energy selling price of each of the plurality of microgrids;

the verification module is configured to form a trading contract and perform a verification based on information of the first power dispatching-matching, the second power dispatching-matching and the third power dispatching-matching, and then send the information of the first power dispatching-matching, the second power dispatching-matching and the third power dispatching-matching to the sorting node of the microgrid blockchain corresponding to each of two trading subject parties and update the microgrid blockchain corresponding to each of two trading subject parties after passing the verification;

the trading module is configured to perform an electricity trading based on the trading contract, and record actual trading data on the microgrid blockchain corresponding to each of two trading subject parties.

In a third aspect, this application provides a storage medium, wherein the storage medium stores computer programs for peer-to-peer electricity trading based on a double-layer blockchain; wherein the computer programs are configured to allow a computer to execute the method for peer-to-peer electricity trading based on a double-layer blockchain mentioned above.

In a fourth aspect, this application provides an electronic device, comprising:

one or more processors;

a memory; and

one or more programs;

wherein the one or more programs are stored in the memory and configured to be executed by the one or more processors; and the programs comprises the method for peer-to-peer electricity trading based on a double-layer blockchain mentioned above.

Compared with the prior art, this application has the following beneficial effects.

This application provides a method, a system, a storage medium and an electronic device for peer-to-peer electricity trading based on a double-layer blockchain.

1. This application includes a bulk grid blockchain and a plurality of microgrid blockchains, and puts forward the double-layer blockchain technology. The energy consumption plan or the energy supply plan of the trading subjects shall preferentially perform a first power dispatching-matching and a second power dispatching-matching on the microgrid blockchain, and the unsatisfied energy consumption plan or the remaining energy supply plan is uploaded to large power grid blockchain for a third power dispatching-matching, which effectively alleviates the pressure on the information storage capacity, threshold-crossing of power flow, and calculation demand resulted from the excessive blockchain nodes. Moreover, the blockchain technology has the characteristics of decentralization, openness and transparency and tamper resistance, such that the challenges brought by the centralized structure in the traditional power operation can be conquered.

2. In this application, the trading dispatching price is processed by the price elastic interval dispatching and multi-objective function optimization at the same time. If the ratio of the quoted price difference of energy supply and consumption subject/microgrid to the weighted average price of energy supply and consumption subject/microgrid is no more than 0.05, the electricity trading can be directly conducted by default. Otherwise, the multi-objective function optimization is conducted to optimize the price, which not only simplifies the trading price negotiation and improves the efficiency of the peer-to-peer electricity trading process, but also maximizes the revenue of the energy supply subject and minimizes the expenditure of the energy consumption subject.

### BRIEF DESCRIPTION OF THE DRAWINGS

In order to make the technical solutions of this disclosure clearer, this disclosure will be described in detail below with reference to the accompanying drawings and embodiments. Obviously, it should be noted that the embodiments described blow are merely some embodiments of this disclosure. It should be understood for those of ordinary skill in the art that other accompanying drawings can also be obtained by the following accompanying drawings without paying any creative efforts.

FIG. 1 is a flowchart of a method for peer-to-peer electricity trading based on a double-layer blockchain according to an embodiment of this application; and

FIG. 2 is a structural diagram of a system for peer-to-peer electricity trading based on a double-layer blockchain according to an embodiment of this application.

### DETAILED DESCRIPTION OF EMBODIMENTS

In order to make the objectives, technical solutions and beneficial effects in the embodiments of this disclosure more clear and complete, this disclosure will be described in detail below with reference to the accompanying drawings. Obviously, the embodiments described blow are merely some embodiments of this disclosure. Based on the embodiments of this disclosure, it should be understood that any modifications and replacements made by those skilled in the art without departing from the spirit of this disclosure should fall within the scope of this application defined by the appended claims.

An objective of this application is to provide a method, a system, a storage medium and an electronic device for peer-to-peer electricity trading based on a double-layer blockchain, which alleviates the pressure on the information storage capacity, threshold-crossing of power flow, and calculation demand resulted from the excessive blockchain nodes.

The technical solutions in the embodiments of this disclosure are provided to solve the above-mentioned technical problems, and the general idea is as follows:

This application includes a bulk grid blockchain and a plurality of microgrid blockchains and puts forward the double-layer blockchain technology. The energy consumption plan or the energy supply plan of the trading subjects shall preferentially perform a first power dispatching-matching and a second power dispatching-matching on the microgrid blockchain, and the unsatisfied energy consumption plan or the remaining energy supply plan is uploaded to large power grid blockchain for a third power dispatching-matching, which effectively alleviates the pressure of on the information storage capacity, threshold-crossing of power flow, and calculation demand resulted from the excessive blockchain nodes. Moreover, the blockchain technology has the characteristics of decentralization, openness and transparency and tamper resistance, such that the challenges brought by the centralized structure in the traditional power operation can be conquered.

In order to better understand the above-mentioned technical solutions, this disclosure will be described in detail below with reference to the accompanying drawings and embodiments.

### Embodiment 1

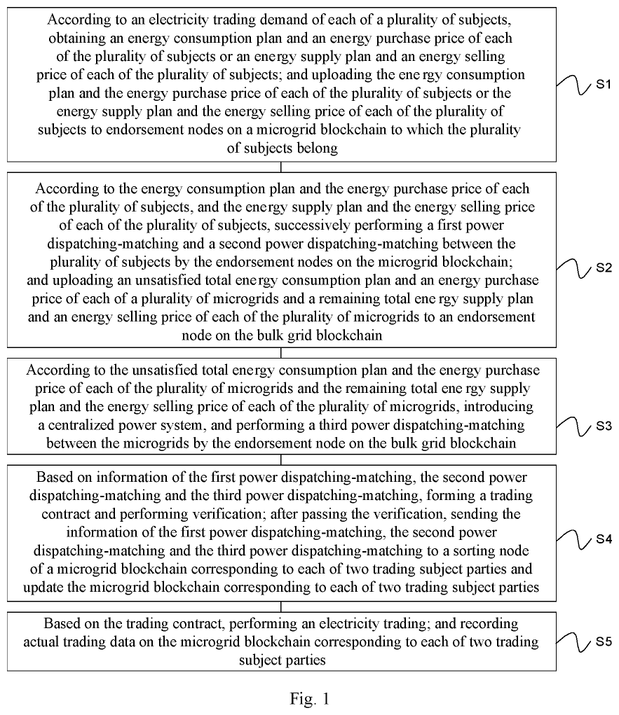

In a first aspect, referring to an embodiment shown in FIG. 1, this application provides a method for peer-to-peer electricity trading based on a double-layer blockchain. The method is performed based on a bulk grid blockchain and a plurality of microgrid blockchains. The method is performed as follows.

(S1) According to an electricity trading demand of each of a plurality of subjects, an energy consumption plan and an energy purchase price of each of the plurality of subjects and an energy supply plan and an energy selling price of each of the plurality of subjects are obtained. The energy consumption plan and the energy purchase price of each of the plurality of subjects and the energy supply plan and the energy selling price of each of the plurality of subjects are uploaded to endorsement nodes on a microgrid blockchain to which the plurality of subjects belong.

(S2) According to the energy consumption plan and the energy purchase price of each of the plurality of subjects, and the energy supply plan and the energy selling price of each of the plurality of subjects, a first power dispatching-matching and a second power dispatching-matching are performed between the plurality of subjects by the endorsement nodes on the microgrid blockchain. An unsatisfied total energy consumption plan and an energy purchase price of the microgrid and a remaining total energy supply plan and an energy selling price of the microgrid are uploaded to an endorsement node on the bulk grid blockchain.

(S3) According to the unsatisfied total energy consumption plan and the energy purchase price of the microgrid and the remaining total energy supply plan and the energy selling price of the microgrid, a centralized power system is introduced, and a third power dispatching-matching is performed between the plurality of microgrids by the endorsement node on the bulk grid blockchain.

(S4) Based on information of the first power dispatching-matching, the second power dispatching-matching and the third power dispatching-matching, a trading contract is formed and verified. After passing the verification, the information of the first power dispatching-matching, the second power dispatching-matching and the third power dispatching-matching is sent to a sorting node of a microgrid blockchain corresponding to each of two trading subject parties to update the corresponding microgrid blockchain.

(S5) Based on the trading contract, an electricity trading is performed. The actual trading data is recorded on the microgrid blockchain corresponding to each of two trading subject parties.

This application includes a bulk grid blockchain and a plurality of microgrid blockchains and puts forward the double-layer blockchain technology. The energy consumption plan or the energy supply plan of the trading subjects shall preferentially perform a first power dispatching-matching and a second power dispatching-matching on the microgrid blockchain, and the unsatisfied energy consumption plan or the remaining energy supply plan is uploaded to large power grid blockchain for a third power dispatching-matching, which effectively alleviates the pressure on the information storage capacity, threshold-crossing of power flow, and calculation demand resulted from the excessive blockchain nodes. Moreover, the blockchain technology has the characteristics of decentralization, openness and transparency and tamper resistance, such that the challenges brought by the integration of a large number of prosumers into the centralized structure in the traditional power operation mentioned in the background can be conquered.

The steps of the above technical solution are specifically described as follows.

In this embodiment, it should be noted that assuming that the energy consumption plan of the large power grid is much larger than the energy supply plan of the large power grid, it is necessary to introduce a centralized power system (centralized power supplier) to supply the power in the final dispatching-matching. Moreover, each of the subjects in each microgrid is a blockchain node on the microgrid blockchain to which the plurality of subjects belong.

(S 1) According to the electricity trading demand of each of the plurality of subjects, an energy consumption plan and an energy purchase price of each of the plurality of subjects or an energy supply plan and an energy selling price of each of the plurality of subjects are obtained and uploaded to endorsement nodes on a microgrid blockchain to which the plurality of subjects belong.

In order to allow each of the plurality of subjects to participate in the subsequent power dispatching-matching, it is necessary to assign an access permission for each of the plurality of subjects to participate in the electricity trading before step (S1). Specifically, a regulator in the system for peer-to-peer electricity trading based on a double-layer blockchain is capable of completing the empowering work.

In this step, based on historical data and personal preferences or any other indicators, the electricity trading demand of each of the plurality of subjects is determined, so as to determine whether the subject is taken as an energy supply subject or an energy consumption subject in the subsequent power dispatching-matching.

If the subject is determined to be an energy supply subject, an energy supply plan of the subject and a corresponding energy selling price are required to be uploaded to the endorsement node of the microgrid to which the subject belongs. If the subject is determined to be an energy consumption subject, an energy consumption plan of the subject and a corresponding energy purchase price are required to be uploaded to the endorsement node of the microgrid to which the subject belongs, until all the subjects in the microgrid complete the uploading.

The endorsement nodes on the microgrid blockchain includes a first endorsement node M₁^{e}, a second endorsement node M₂^{e} and a third endorsement node M₃^{e}, which will be specifically illustrated in the following steps.

(S2) According to the energy consumption plan and the energy purchase price of each of the plurality of subjects, and the energy supply plan and the energy selling price of each of the plurality of subjects, a first power dispatching-matching and a second power dispatching-matching are performed successively between the plurality of subjects by the endorsement nodes on the microgrid blockchain. An unsatisfied total energy consumption plan and an energy purchase price of each of a plurality of microgrids and a remaining total energy supply plan and an energy selling price of each of a plurality of microgrids are uploaded to an endorsement node on the bulk grid blockchain.

In this embodiment, the first power dispatching-matching and the second power dispatching-matching are performed successively in the microgrid blockchain, and the unsatisfied total energy consumption plan and the energy purchase price of the microgrid are uploaded to the bulk grid blockchain, alleviating the pressure of the calculation and storage of the system.

The step (S2) is specifically performed as follows.

(S21) According to the energy consumption plan and the energy purchase price of each of the plurality of subjects, and the energy supply plan and the energy selling price of each of the plurality of subjects, the first power dispatching-matching is performed between the subjects by the first endorsement node M₁^{e}.

When e_{c,β}≥e_{p,α}, if

$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$

the first power dispatching-matching is performed between an energy supply subject α and an energy consumption subject β followed by proceeding to step (S4). A first unsatisfied energy consumption plan is uploaded to the second endorsement node M₂^{e}. Otherwise, according to an objective function of preset quoted price information of the energy supply and consumption subject, a corresponding optimized trading price is obtained. Based on the corresponding optimized trading price, the first power dispatching-matching is performed between the energy supply subject α and the energy consumption subject β followed by proceeding to step (S4); and the first unsatisfied energy consumption plan is uploaded to the second endorsement node M₂^{e}.

When e_{c,β}<e_{p,α}, if

$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$

the first power dispatching-matching is performed between the energy supply subject α and the energy consumption subject β followed by proceeding to step (S4). A first remaining energy supply plan is uploaded to the second endorsement node M₂^{e}. Otherwise, according to the objective function of the preset quoted price information of the energy supply and consumption subject, the corresponding optimized trading price is obtained; based on the corresponding optimized trading price, the first power dispatching-matching is performed between the energy supply subject α and the energy consumption subject β followed by proceeding to step (S4). The first remaining energy supply plan is uploaded to the second endorsement node M₂^{e}.

In the formula, e_{p,α} is an energy supply plan of the energy supply subject α; b_{p,α} is an energy selling price of the energy supply subject α; e_{c,β} is an energy consumption plan of the energy consumption subject β; and b_{c,β} is an energy purchase price of the energy purchase subject β.

(S22) According to the first unsatisfied energy consumption plan and the first remaining energy supply plan, the second power dispatching-matching is performed between the plurality of subjects by the second endorsement node M₂^{e}.

When e_{c,δ}≥e_{p,χ}, if

$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$

the second power dispatching-matching is performed between an energy supply subject χ and an energy consumption ϵ followed by proceeding to step (S4). A second unsatisfied energy consumption plan is uploaded to the third endorsement node M₃^{e}. Otherwise, according to an objective function of preset quoted price information of the energy supply and consumption subject, a corresponding optimized trading price is obtained. Based on the corresponding optimized trading price, the second power dispatching-matching is performed between the energy supply subject χ and the energy consumption subject δ followed by proceeding to step (S4). The second unsatisfied energy consumption plan is uploaded to the third endorsement node M₃^{e}.

When e_{c,δ}<e_{p,χ}, if

$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$

the second power dispatching-matching is performed between the energy supply subject χ and the energy consumption subject δ followed by proceeding to step (S4). A second remaining energy supply plan is uploaded to the third endorsement node M₃^{e}. Otherwise, according to the objective function of the preset quoted price information of the energy supply and consumption subject, the corresponding optimized trading price is obtained. Based on the corresponding optimized trading price, the second power dispatching-matching is performed between the energy supply subject χ and the energy consumption subject δ followed by proceeding to step (S4). The second remaining energy supply plan is uploaded to the third endorsement node M₃^{e}.

In the formula, e_{p,χ} is an energy supply plan of the energy supply subject χ; b_{p,χ} is an energy selling price of the energy supply subject χ; e_{c,δ} is an energy consumption plan of the energy consumption subject δ; and b_{c,ϵ} is an energy purchase price of the energy purchase subject δ.

(S23) According to the second unsatisfied energy consumption plan, the energy purchase price, the second remaining energy supply plan and the energy supply price, the unsatisfied total energy consumption plan and the energy purchase price of the microgrid and the remaining total energy consumption plan and the energy selling price of the microgrid are obtained by the third endorsement node M₃^{e} and uploaded to the endorsement node on the bulk grid blockchain.

The third endorsement node M₃^{e} receives the unsatisfied energy consumption plan e_{c} and the quoted price information bₑ and the remaining energy supply plan eₚ and the quoted price information bₚ for the above-mentioned first power dispatching-matching and the second power dispatching-matching on the microgrid, and obtains the remaining total energy supply plan Eₚ=Σᵢ₌₁^{m}e_{p,i} of the microgrid and the energy selling price information

$${B}_{p} = \frac{{e}_{p , 1} * {b}_{p , 1} + {e}_{p , 2} * {b}_{p , 2} + … + {e}_{p , m} * {b}_{p , m}}{{\sum }_{i = 1}^{m} {e}_{p , i}} ,$$

the unsatisfied energy consumption plan E_{c}=Σⱼ₌₁ⁿe_{c,j} and the energy purchase price

$${B}_{c} = \frac{{e}_{c , 1} * {b}_{c , 1} + {e}_{c , 2} * {b}_{c , 2} + … + {e}_{c , n} * {b}_{c , n}}{{\sum }_{j = 1}^{n} {e}_{c , j}} ,$$

where m is the number of remaining energy supply subjects in the microgrid; n is the number of unsatisfied energy consumption subjects; e_{p,i} indicates the remaining energy supply plan of the energy supply subject i; b_{p,i} indicates the the energy selling price of the energy supply subject i; e_{c,j} indicates the unsatisfied energy consumption plan of the energy consumption subject j; and b_{c,j} indicates the energy purchase price of the energy consumption subject j.

The third endorsement node M₃^{e} of each microgrid blockchain sends its remaining total energy supply plan Eₚ and the energy selling price Bₚ , and the unsatisfied energy consumption plan E_{c} and the energy purchase price B_{c} to the endorsement node P₁^{e} on the bulk grid blockchain.

(S3) According to the unsatisfied total energy consumption plan and the energy purchase price of the microgrid and the remaining total energy supply plan and the energy selling price of the microgrid, a centralized power system is introduced, and the third power dispatching-matching between the plurality of microgrids by the endorsement node on the bulk grid blockchain is performed.

The step (S3) is specifically performed as follows.

When E_{c,ψ}≥E_{p,ξ}, if

$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$

the third power dispatching-matching is performed between an energy consumption microgrid ψ and an energy supply microgrid ξ. According to an energy consumption price of an energy consumption subject and an energy selling price of the centralized power system in a second unsatisfied total energy consumption plan, an objective function of quoted price information of the energy supply and consumption subject is solved to obtain a corresponding optimized trading price. According to the corresponding optimized trading price, the third power dispatching-matching is performed followed by proceeding to step (S4).

Otherwise, according to the objective function of the quoted price information of the energy supply and consumption subject, the corresponding optimized trading price is obtained. The third power dispatching-matching is performed between the energy consumption microgrid ψ and the energy supply microgrid according to the optimized trading price. According to the energy consumption price of the energy consumption subject and the energy selling price of the centralized power system in the second unsatisfied total energy consumption plan, the objective function of the quoted price information of the energy supply and consumption subject is solved to obtain a corresponding optimized trading price. According to the corresponding optimized trading price, the third power dispatching-matching is performed followed by proceeding to step (S4).

When E_{c,ψ}<E_{p,ξ}, if

$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$

the third power dispatching-matching is performed between the energy consumption microgrid ψ and the energy supply microgrid ξ followed by proceeding to step (S4). A second remaining total energy supply plan is re-uploaded to the endorsement node on the bulk grid blockchain. Otherwise, according to the objective function of the quoted price information of the energy supply and consumption subject, a corresponding optimized trading price is obtained. The third power dispatching-matching is performed between the energy consumption microgrid ψ and the energy supply microgrid according to the corresponding optimized trading price. The second remaining total energy supply plan is re-uploaded to the endorsement node on the large power grid blockchain followed by proceeding to step (S4).

In the formula, E_{c,ψ} is an energy consumption plan of the energy consumption microgrid ψ; B_{c,ψ} is an energy purchase price of the energy consumption microgrid E_{p,ξ} is an energy supply plan of the energy supply microgrid ξ; B_{p,ξ} is an energy selling price of the energy supply microgrid

(S4) Based on information of the first power dispatching-matching, the second power dispatching-matching and the third power dispatching-matching, a trading contract is formed and verified. After passing the verification, the information of the first power dispatching-matching, the second power dispatching-matching and the third power dispatching-matching is sent to a sorting node of a microgrid blockchain corresponding to each of two trading subject parties and update the microgrid blockchain corresponding to each of two trading subject parties.

In this step, the sorting node packages all transaction contracts that pass the verification into blocks, and updates the microgrid blockchain to which each of two trading parties belongs, respectively.

(S5) Based on the trading contract, an electricity trading is performed. The actual trading data is recorded on the microgrid blockchain corresponding to each of two trading subject parties.

The step (S5) is specifically performed as follows.

If the trading contract is not fulfilled or there is a breach of the trading contract during a trading fulfillment, a party at fault bears a corresponding breach of contract liability and pays a penalty. If the trading contract is fulfilled successfully, based on actual trading data provided by a smart electricity meter, a trading fee is automatically transferred, and the actual trading data is recorded on the microgrid blockchain corresponding to each of two trading subject parties, so as to complete the electricity trading.

Specifically, the objective function of the quoted price information of the energy supply and consumption subject includes a maximization of a selling power revenue of the energy supply subject, which is expressed as follows:

max u_{p,i}(b_{p,i}, B_{p,-i}, B_{c,j});

and a minimization of a purchase power expenditure of the energy consumption subject, which is expressed as follows:

min u_{c,j}(b_{c,j}, B_{c,-j}, B_{p,i});

where u_{p,i} is a utility function of an energy supply subject/microgrid i; b_{p,i} is a quoted price of the energy supply subject/microgrid i; B_{p,-i} is a quoted price of energy supply subjects/microgrids except for the energy supply subject/microgrid i; B_{c,j} indicates all quoted prices of energy consumption subjects/microgrids; u_{c,j} is a utility function of an energy consumption subject/microgrid j; b_{c,j} is a quoted price of the energy consumption subject/microgrid j; B_{c,-j} is a quoted price of the energy consumption subjects/microgrids except for the energy consumption subject/microgrid j; and B_{p,i} indicates all quoted prices of energy supply subjects/microgrids.

Corresponding constraints are illustrated as follows.

(1) An upper limit constraint and a lower limit constraint of an output of the energy supply subject/microgrid are expressed as follows:

Q_{p,i}^{min}≤Q_{p,i}≤Q_{p,i}^{max};

where Q_{p,i}^{min} is a lower limit of the amount of power supply of the energy supply subject/microgrid; Q_{p,i}^{max} is an upper limit of the amount of power supply of the energy supply subject/microgrid; and Q_{p,i} indicates the amount of power supply of the energy supply subject/microgrid i.

(2) An upper limit constraint and a lower limit constraint of the amount of power purchased by the energy consumption subject/microgrid are expressed as follows:

Q_{c,j}^{min}≤Q_{c,j}≤Q_{c,j}^{max};

where Q_{c,j}^{min} is a lower limit of the amount of power purchased by the energy consumption subject/microgrid; Q_{c,j}^{max} is an upper limit of the amount of power purchased by the energy consumption subject/microgrid; and Q_{c,j} indicates the amount of power purchased by an energy consumption subject/microgrid j.

It should be noted that when the price difference between the two adjacent rounds of the energy supply subject/microgrid and the energy consumption subject/microgrid is less than a small positive value, the quoted prices of market members converge to the Nash equilibrium solution. At this time, any market member fails to regulate its own quoted price to optimize the utility function, and a basis of the convergence is expressed as follows:

|b_{p,i}^{(k+1)}−b_{p,i}^{(k)}|≤ε;

|b_{c,j}^{(k+1)}−b_{c,j}^{(k)}|≤ε;

where ε is a small positive value.

According to the objective function, the corresponding optimized trading price is obtained based on a strategy of an optimal response.

(1) A dynamic regulation process of the optimal response of a quoted price of the energy consumption subject/microgrid is expressed as follows:

τ_{c,j}(B_{p,i}, B_{c,-j})={b_{c,j}^{*}∈B_{c,j}|u_{c,j}(b_{c,j}^{*}, B_{c,-j}^{*}, B_{p,i}^{*})≤u_{c,j}(b_{c,j}, B_{c,-j}^{*}, B_{p,i}^{*}), ∀b_{c,j}∈B_{c,j}};

where τ_{c,j} is a quoted price of the energy consumption subject/microgrid j; b_{c,j}^{*} is a quoted price of the optimal response of the energy consumption subject/microgrid j; B_{c,-j}^{*} is a quoted price of the energy consumption subjects/microgrids except for the energy consumption subject/microgrid j; B_{p,i}^{*} is a quoted price of all the energy supply subjects/microgrids i.

$${r}_{c , j} ( {B}_{p , i} , {B}_{c , - j} ) = arg {min}_{{b}_{c , j} ∈ {B}_{c , j}} {u}_{c , j} ( {b}_{c , j} , {B}_{c , - j}^{*} , {B}_{p , i}^{*} ) .$$

A quoted price of all energy supply subjects/microgrids and a quoted price of energy consumption subjects/microgrids except for the energy consumption subject/microgrid j in the market are ensured to remain unchanged. An optimal response of each energy consumption subject/microgrid is determined according to a corresponding quoted price, that is, among all available quoted prices of the energy consumption subject/microgrid j, there is b_{c,j}^{*} to minimum a corresponding utility.

(2) A dynamic regulation process of an optimal response of a quoted price of the energy supply subject/microgrid is expressed as follows:

τ_{p,i}(B_{p,-i}, B_{c,j})={b_{p,i}^{*}∈B_{p,i}|u_{p,i}(b_{p,i}^{*}, B_{p,-i}^{*}, B_{c,j}^{*})≥u_{p,i}(b_{p,i}, B_{p,-i}^{*}, B_{c,j}^{*}), ∀b_{p,i}∈B_{p,i}};

where τ_{p,i} is a quoted price of the energy supply subject/microgrid i; b_{p,i}^{*} is a quoted price of the optimal response of the energy supply subject/microgrid i; B_{p,-i}^{*} is a quoted price of the energy supply subjects/microgrids except for the energy supply subject/microgrid i; B_{c,j}^{*} is a quoted price of all the energy supply subjects/microgrids

$${r}_{p , i} ( {B}_{p , - i} , {B}_{c , j} ) = arg {min}_{{b}_{p , i} ∈ {B}_{p , i}} {u}_{p , i} ( {b}_{p , i} , {B}_{p , - i}^{*} , {B}_{c , j}^{*} ) .$$

A quoted price of all energy consumption subjects/microgrids and a quoted price of energy supply subjects/microgrids except for energy supply subject/microgrid i in the market are ensured to remain unchanged. An optimal response of each energy supply subject/microgrid is determined according to a corresponding quoted price, that is, among all available quoted prices of the energy supply subject/microgrid there is b_{p,i}^{*} to maximum a corresponding utility.

In this embodiment, the trading dispatching price is processed by performing the price elastic interval dispatching and multi-objective function optimization at the same time. If the ratio of the quoted price difference of energy supply and consumption subject/microgrid to the weighted average price of energy supply and consumption subject/microgrid is no more than 0.05, the electricity trading can be directly conducted by default. Otherwise, the multi-objective function optimization is conducted to optimize the price, which not only simplifies the trading price negotiation and improves the efficiency of the peer-to-peer electricity trading process, but also maximizes the revenue of the energy supply subject and minimizes the expenditure of the energy consumption subject.

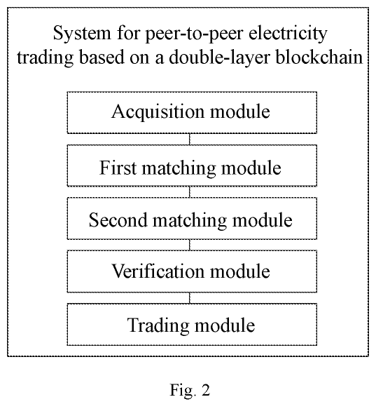

In a second aspect, referring to an embodiment shown in FIG. 2, this application provides a system for peer-to-peer electricity trading based on a double-layer blockchain. The system comprises a bulk grid blockchain and a plurality of microgrid blockchains. The method specifically includes an acquisition module, a first matching module, a second matching module, a verification module and a trading module.

The acquisition module is configured to acquire an energy consumption plan and an energy purchase price of each of a plurality of subjects and an energy supply plan and an energy selling price of each of the plurality of subjects according to an electricity trading demand of each of the plurality of subjects, and upload the energy consumption plan and the energy purchase price of each of the plurality of subjects and the energy supply plan and the energy selling price of each of the plurality of subjects to endorsement nodes on a microgrid blockchain to which the plurality of subjects belong.

The first matching module is configured to successively perform a first power dispatching-matching and a second power dispatching-matching between the plurality of subjects through the endorsement nodes on the microgrid blockchain according to the energy consumption plan and the energy purchase price of each of the plurality of subjects, and the energy supply plan and the energy selling price of each of the plurality of subjects, and upload an unsatisfied total energy consumption plan and an energy purchase price of the microgrid and a remaining total energy supply plan and an energy selling price of the microgrid to an endorsement node on the bulk grid blockchain.

The second matching module is configured to perform a third power dispatching-matching between microgrids by the endorsement node on the bulk grid blockchain under a premise that a centralized power system is introduced, according to the unsatisfied total energy consumption plan and the energy purchase price of the microgrid and the remaining total energy supply plan and the energy selling price of the microgrid.

The verification module is configured to form a trading contract and perform a verification based on information of the first power dispatching-matching, the second power dispatching-matching and the third power dispatching-matching, and then send the information of the first power dispatching-matching, the second power dispatching-matching and the third power dispatching-matching to a sorting node of a microgrid blockchain corresponding to each of two trading subject parties and update the microgrid blockchain corresponding to each of two trading subject parties after passing the verification.

The trading module is configured to perform an electricity trading based on the trading contract, and record actual trading data on the microgrid blockchain corresponding to each of two trading subject parties.

In a third aspect, this application provides a storage medium. The storage medium stores computer programs for a peer-to-peer electricity trading based on a double-layer blockchain. The computer programs are configured to allow a computer to execute the method for peer-to-peer electricity trading based on a double-layer blockchain mentioned above.

In a fourth aspect, this application provides an electronic device. The electronic device includes one or more processors, a memory and one or more programs. The one or more programs are stored in the memory and configured to be executed by the one or more processors. The programs include the method for peer-to-peer electricity trading based on a double-layer blockchain mentioned above.

It should be understood that the system for peer-to-peer electricity trading, storage medium and electronic device based on a double-layer blockchain provided herein corresponds to the above-mentioned method for peer-to-peer electricity trading based on a double-layer blockchain. The explanation, examples, beneficial effects and other parts of the relevant content of the system can be referred by the corresponding content in the method, and will not be repeated herein.

Compared with the prior art, this application has the following beneficial effects.

1. This application includes a bulk grid blockchain and a plurality of microgrid blockchains, and puts forward the double-layer blockchain technology. The energy consumption plan or the energy supply plan of the trading subjects shall preferentially perform a first power dispatching-matching and a second power dispatching-matching on the microgrid blockchain, and the unsatisfied energy consumption plan or the remaining energy supply plan is uploaded to large power grid blockchain for a third power dispatching-matching, which effectively alleviates the pressure of on the information storage capacity, threshold-crossing of power flow, and calculation demand resulted from the excessive blockchain nodes. Moreover, the blockchain technology has the characteristics of decentralization, openness and transparency and tamper resistance, such that the challenges brought by the centralized structure in the traditional power operation can be conquered.

2. In this application, the trading dispatching price is processed by performing the price elastic interval dispatching and multi-objective function optimization at the same time. If the ratio of the quoted price difference of energy supply and consumption subject/microgrid to the weighted average price of energy supply and consumption subject/microgrid is no more than 0.05, the electricity trading can be directly conducted by default. Otherwise, the multi-objective function optimization is conducted to optimize the price, which not only simplifies the trading price negotiation and improves the efficiency of the peer-to-peer electricity trading process, but also maximizes the revenue of the energy supply subject and minimizes the expenditure of the energy consumption subject.

It should be noted that as used herein, relational terms such as “first” and “second” are merely intended to distinguish one entity or operation from another entity or operation, and do not necessarily require or imply such an actual relationship or order between these entities or operations. Furthermore, the term “comprise”, “include”, “contain” or any other variations are intended to encompass a non-exclusive inclusion, such that a process, method, article, or instrument not only includes those listed elements, but also includes those that are not clearly listed, or those elements that are inherent to such a process, method, article, or instrument. If there are no more restrictions, the elements defined by the sentence “comprising . . . ” do not exclude the existence of other identical elements in the process, method, article, or instrument comprising the elements.

Described above are merely described to illustrate the technical solutions of this disclosure, but not intended to limit this disclosure. It should be understood for those of ordinary skill in the art that any modifications of the technical solutions described in the above embodiments or the equivalent replacement of the part of the technical features can be made without departing from the spirit of the application should still fall within the scope of the present application defined by the appended claims.

What is claimed is:

1. A method for peer-to-peer electricity trading based on a double-layer blockchain, wherein the method is performed through a bulk grid blockchain and a plurality of microgrid blockchains; and the method comprises:
(S1) according to an electricity trading demand of each of a plurality of subjects, obtaining an energy consumption plan and an energy purchase price of each of the plurality of subjects, and an energy supply plan and an energy selling price of each of the plurality of subjects; and uploading the energy consumption plan and the energy purchase price of each of the plurality of subjects and the energy supply plan and the energy selling price of each of the plurality of subjects to endorsement nodes on a microgrid blockchain to which the plurality of subjects belong;
(S2) according to the energy consumption plan and the energy purchase price of each of the plurality of subjects, and the energy supply plan and the energy selling price of each of the plurality of subjects, successively performing a first power dispatching-matching and a second power dispatching-matching between the plurality of subjects by the endorsement nodes on the microgrid blockchain; and uploading an unsatisfied total energy consumption plan and an energy purchase price of each of a plurality of microgrids and a remaining total energy supply plan and an energy selling price of each of the plurality of microgrids to an endorsement node on the bulk grid blockchain;
(S3) according to the unsatisfied total energy consumption plan and the energy purchase price of each of the plurality of microgrids and the remaining total energy supply plan and the energy selling price of each of the plurality of microgrids, introducing a centralized power system, and performing a third power dispatching-matching between the plurality of microgrids by the endorsement node on the bulk grid blockchain;
(S4) based on information of the first power dispatching-matching, the second power dispatching-matching and the third power dispatching-matching, forming a trading contract and performing verification; after passing the verification, sending the information of the first power dispatching-matching, the second power dispatching-matching and the third power dispatching-matching to a sorting node of a microgrid blockchain corresponding to each of two trading subject parties and update the microgrid blockchain corresponding to each of two trading subject parties; and
(S5) based on the trading contract, performing an electricity trading; and recording actual trading data on the microgrid blockchain corresponding to each of two trading subject parties.

2. The method of claim 1, wherein the step (S2) further comprises:
(S21) according to the energy consumption plan and the energy purchase price of each of the plurality of subjects, and the energy supply plan and the energy selling price of each of the plurality of subjects, performing the first power dispatching-matching by a first endorsement node; wherein the endorsement nodes on the microgrid blockchain comprises the first endorsement node, a second endorsement node and a third endorsement node;
when e_{c,β}≤e_{p,α}, if
$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$
performing the first power dispatching-matching between an energy supply subject α and an energy consumption subject β followed by proceeding to step (S4); uploading a first unsatisfied energy consumption plan to the second endorsement node; otherwise, according to an objective function of preset quoted price information of the energy supply and consumption subject, obtaining a corresponding optimized trading price; based on the corresponding optimized trading price, performing the first power dispatching-matching between the energy supply subject α and the energy consumption subject β followed by proceeding to step (S4); and uploading the first unsatisfied energy consumption plan to the second endorsement node;
when e_{c,β}<e_{p,α}, if
$$\vert \frac{( {b}_{p , α} - {b}_{c , β} ) ( {e}_{p , α} + {e}_{c , β} )}{{b}_{p , α} * {e}_{p , α} + {b}_{c , β} * {e}_{c , β}} \vert \leq 0.05 ,$$
performing the first power dispatching-matching between the energy supply subject α and the energy consumption subject β followed by proceeding to step (S4); uploading a first remaining energy supply plan to the second endorsement node; otherwise, according to the objective function of the preset quoted price information of the energy supply and consumption subject, obtaining the corresponding optimized trading price; based on the corresponding optimized trading price, performing the first power dispatching-matching between the energy supply subject α and the energy consumption subject β followed by proceeding to step (S4); and uploading the first remaining energy supply plan to the second endorsement node;
wherein e_{p,α} is an energy supply plan of the energy supply subject α; b_{p,α} is an energy selling price of the energy supply subject α; e_{c,β} is an energy consumption plan of the energy consumption subject β; and b_{c,β} is an energy purchase price of the energy purchase subject β;
(S22) according to the first unsatisfied energy consumption plan and the first remaining energy supply plan, performing the second power dispatching-matching between the plurality of subjects by the second endorsement node;
when e_{c,δ}≥e_{p,χ}, if
$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$
performing the second power dispatching-matching between an energy supply subject χ and an energy consumption ϵ followed by proceeding to step (S4); uploading a second unsatisfied energy consumption plan to the third endorsement node; otherwise, according to an objective function of preset quoted price information of the energy supply and consumption subject, obtaining a corresponding optimized trading price; based on the corresponding optimized trading price, performing the second power dispatching-matching between the energy supply subject χ and the energy consumption subject δ followed by proceeding to step (S4); and uploading the second unsatisfied energy consumption plan to the third endorsement node;
when e_{c,δ}<e_{p,χ}, if
$$\vert \frac{( {b}_{p , χ} - {b}_{c , δ} ) ( {e}_{p , χ} + {e}_{c , δ} )}{{b}_{p , χ} * {e}_{p , χ} + {b}_{c , δ} * {e}_{c , δ}} \vert \leq 0.05 ,$$
performing the second power dispatching-matching between the energy supply subject χ and the energy consumption subject δ followed by proceeding to step (S4); uploading a second remaining energy supply plan to the third endorsement node; otherwise, according to the objective function of the preset quoted price information of the energy supply and consumption subject, obtaining the corresponding optimized trading price; based on the corresponding optimized trading price, performing the second power dispatching-matching between the energy supply subject χ and the energy consumption subject δ followed by proceeding to step (S4); and uploading the second remaining energy supply plan to the third endorsement node;
wherein e_{p,χ} is an energy supply plan of the energy supply subject χ; b_{p,ψ} is an energy selling price of the energy supply subject x; eₙₛ is an energy consumption plan of the energy consumption subject δ; and b_{c,δ} is an energy purchase price of the energy purchase subject δ; and
(S23) according to the second unsatisfied energy consumption plan and the energy purchase price and the second remaining energy supply plan and the energy supply price, obtaining the unsatisfied total energy consumption plan and the energy purchase price of each of the plurality of microgrids and the remaining total energy consumption plan and the energy selling price of each of the plurality of microgrids by the third endorsement node; and uploading the unsatisfied total energy consumption plan and the energy purchase price of each of the plurality of microgrids and the remaining total energy consumption plan and the energy selling price of each of the plurality of microgrids to the endorsement node on the bulk grid blockchain.

3. The method of claim 2, wherein the step (S3) further comprises:
when E_{c,ψ}≥E_{p,ξ}, if
$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$
performing the third power dispatching-matching between an energy consumption microgrid ψ and an energy supply microgrid ξ; according to an energy consumption price of an energy consumption subject and an energy selling price of the centralized power system in a second unsatisfied total energy consumption plan, solving an objective function of quoted price information of the energy supply and consumption subject to obtain a corresponding optimized trading price; and according to the corresponding optimized trading price, performing the third power dispatching-matching followed by proceeding to step (S4); otherwise, according to the objective function of the quoted price information of the energy supply and consumption subject, obtaining the corresponding optimized trading price; performing the third power dispatching-matching between the energy consumption microgrid ψ and the energy supply microgrid ξ according to the optimized trading price; according to the energy consumption price of the energy consumption subject and the energy selling price of the centralized power system in the second unsatisfied total energy consumption plan, solving the objective function of the quoted price information of the energy supply and consumption subject to obtain a corresponding optimized trading price; and according to the corresponding optimized trading price, performing the third power dispatching-matching followed by proceeding to step (S4);
when E_{c,ψ}<E_{p,ξ}, if
$$\vert \frac{( {B}_{p , ξ} - {B}_{c , ψ} ) ( {E}_{p , ξ} + {E}_{c , ψ} )}{{B}_{p , ξ} * {E}_{p , ξ} + {B}_{c , ψ} * {E}_{c , ψ}} \vert \leq 0.05 ,$$
performing the third power dispatching-matching between the energy consumption microgrid ψ and the energy supply microgrid ξ followed by proceeding to step (S4); re-uploading a second remaining total energy supply plan to the endorsement node on the bulk grid blockchain; otherwise, according to the objective function of the quoted price information of the energy supply and consumption subject, obtaining a corresponding optimized trading price; performing the third power dispatching-matching between the energy consumption microgrid ψ and the energy supply microgrid according to the corresponding optimized trading price; re-uploading the second remaining total energy supply plan to the endorsement node on the large power grid blockchain followed by proceeding to step (S4);
wherein E_{c,ψ} is an energy consumption plan of the energy consumption microgrid ψ; B_{c,ψ} is an energy purchase price of the energy consumption microgrid E_{p,ξ} is an energy supply plan of the energy supply microgrid ξ; B_{p,ξ} is an energy selling price of the energy supply microgrid ξ.

4. The method of claim 2, wherein the objective function of the quoted price information of the energy supply and consumption subject comprises a maximization of a selling power revenue of the energy supply subject, which is expressed as follows:
max u_{p,i}(b_{p,i}, B_{p,-i}, B_{c,j});
and a minimization of a purchase power expenditure of the energy consumption subject, which is expressed as follows:
min u_{c,j}(b_{c,j}, B_{c,-j}, B_{p,i});
wherein u_{p,i} is a utility function of an energy supply subject/microgrid i; b_{p,i} is a quoted price of the energy supply subject/microgrid i; B_{p,-i} is a quoted price of energy supply subjects/microgrids except for the energy supply subject/microgrid i; B_{c,j} indicates all quoted prices of energy consumption subjects/microgrids; u_{c,j} is a utility function of an energy consumption subject/microgrid j; b_{c,j} is a quoted price of the energy consumption subject/microgrid j; B_{c,-j} is a quoted price of energy consumption subjects/microgrids except for the energy consumption subject/microgrid j; and B_{p,i} indicates all quoted prices of energy supply subjects/microgrids;
corresponding constraints comprise:
(1) an upper limit constraint and a lower limit constraint of an output of the energy supply subject/microgrid are expressed as follows:
Q_{p,i}^{min}≤Q_{p,i}≤Q_{p,i}^{max};
wherein Q_{p,i}^{min} is a lower limit of the amount of power supply of the energy supply subject/microgrid; Q_{p,i}^{max} is an upper limit of the amount of power supply of the energy supply subject/microgrid; and Q_{p,i} indicates the amount of power supply of the energy supply subject/microgrid i;
(2) an upper limit constraint and a lower limit constraint of the amount of power purchased by the energy consumption subject/microgrid are expressed as follows:
Q_{c,j}^{min}≤Q_{c,j}≤Q_{c,j}^{max};
wherein Q_{c,j}^{min} is a lower limit of the amount of power purchased by the energy consumption subject/microgrid; Q_{c,j}^{max} is an upper limit of the amount of power purchased by the energy consumption subject/microgrid; and Q_{c,j} indicates the amount of power purchased by an energy consumption subject/microgrid j.

5. The method of claim 4, wherein according to the objective function, obtaining the corresponding optimized trading price based on a strategy of an optimal response;
(1) a dynamic regulation process of the optimal response of a quoted price of the energy consumption subject/microgrid is expressed as follows:
τ_{c,j}(B_{p,i}, B_{c,-j})={b_{c,j}^{*}∈B_{c,j}|u_{c,j}(b_{c,j}^{*}, B_{c,-j}^{*}, B_{p,i}^{*})≤u_{c,j}(b_{c,j}, B_{c,-j}^{*}, B_{p,i}^{*}), ∀b_{c,j}∈B_{c,j}};
wherein τ_{c,j} is a quoted price of the energy consumption subject/microgrid j; b_{c,j}^{*} is a quoted price of the optimal response of the energy consumption subject/microgrid j; B_{c,-j}^{*} is a quoted price of energy consumption subjects/microgrids except for the energy consumption subject/microgrid j; B_{p,i}^{*} is a quoted price of all the energy supply subjects/microgrids i;
$${r}_{c , j} ( {B}_{p , i} , {B}_{c , - j} ) = arg {min}_{{b}_{c , j} ∈ {B}_{c , j}} {u}_{c , j} ( {b}_{c , j} , {B}_{c , - j}^{*} , {B}_{p , i}^{*} ) ;$$
ensuring a quoted price of all energy supply subjects/microgrids and a quoted price of energy consumption subjects/microgrids except for energy consumption subject/microgrid j in the market remain unchanged; determining an optimal response of each energy consumption subject/microgrid according to a corresponding quoted price, that is, among all available quoted prices of the energy consumption subject/microgrid j, there is B_{p,i}^{*} to minimum a corresponding utility; and
(2) a dynamic regulation process of an optimal response of a quoted price of the energy supply subject/microgrid is expressed as follows:
τ_{p,i}(B_{p,-i}, B_{c,j})={b_{p,i}^{*}∈B_{p,i}|u_{p,i}(b_{p,i}^{*}, B_{p,-i}^{*}, B_{c,j}^{*})≥u_{p,i}(b_{p,i}, B_{p,-i}^{*}, B_{c,j}^{*}), ∀b_{p,i}∈B_{p,i}};
wherein τ_{p,i} is a quoted price of the energy supply subject/microgrid i; by, b_{p,i} is a quoted price of the optimal response of the energy supply subject/microgrid i; B_{p,-i}^{*}, is a quoted price of the energy supply subjects/microgrids except for the energy supply subject/microgrid i; B_{c,j}^{*} is a quoted price of all the energy supply subjects/microgrids j;
$${r}_{p , i} ( {B}_{p , - i} , {B}_{c , j} ) = arg {min}_{{b}_{p , i} ∈ {B}_{p , i}} {u}_{p , i} ( {b}_{p , i} , {B}_{p , - i}^{*} , {B}_{c , j}^{*} ) ;$$
ensuring a quoted price of all energy consumption subjects/microgrids and a quoted price of energy supply subjects/microgrids except for energy supply subject/microgrid i in the market remain unchanged; determining an optimal response of each energy supply subject/microgrid according to a corresponding quoted price, wherein it indicates that among all available quoted prices of the energy supply subject/microgrid i, there is b_{p,i}^{*} to maximum a corresponding utility.

6. The method of claim 4, wherein step (S5) further comprises:
if the trading contract is not fulfilled or there is a breach of the trading contract during a trading fulfillment, bearing a corresponding breach of contract liability and paying a penalty by a party at fault; if the trading contract is fulfilled successfully, based on actual trading data provided by a smart electricity meter, automatically transferring a trading fee, and recording the actual trading data on the microgrid blockchain corresponding to each of two trading subject parties, so as to complete the electricity trading.

7. The method of claim 4, wherein the method further comprises: before step (S1), assigning an access permission for each of the plurality of subjects to participate in the electricity trading.

8. A system for peer-to-peer electricity trading based on a double-layer blockchain, wherein the system comprises a bulk grid blockchain and a plurality of microgrid blockchains; and the system further comprises:
an acquisition module;
a first matching module;
a second matching module;
a verification module; and
a trading module;
wherein the acquisition module is configured to acquire an energy consumption plan and an energy purchase price of each of a plurality of subjects and an energy supply plan and an energy selling price of each of the plurality of subjects according to an electricity trading demand of each of the plurality of subjects, and upload the energy consumption plan and the energy purchase price of each of the plurality of subjects and the energy supply plan and the energy selling price of each of the plurality of subjects to endorsement nodes on a microgrid blockchain to which the plurality of subjects belong;
the first matching module is configured to successively perform a first power dispatching-matching and a second power dispatching-matching between the plurality of subjects through the endorsement nodes on the microgrid blockchain according to the energy consumption plan and the energy purchase price of each of the plurality of subjects, and the energy supply plan and the energy selling price of each of the plurality of subjects, and upload an unsatisfied total energy consumption plan and an energy purchase price of each of a plurality of microgrids and a remaining total energy supply plan and an energy selling price of each of the plurality of microgrids to an endorsement node on the bulk grid blockchain;
the second matching module is configured to perform a third power dispatching-matching between the plurality of microgrids by the endorsement node on the bulk grid blockchain under a premise that a centralized power system is introduced, according to the unsatisfied total energy consumption plan and the energy purchase price of each of the plurality of microgrids and the remaining total energy supply plan and the energy selling price of each of the plurality of microgrids;
the verification module is configured to form a trading contract and perform a verification based on information of the first power dispatching-matching, the second power dispatching-matching and the third power dispatching-matching, and then send the information of the first power dispatching-matching, the second power dispatching-matching and the third power dispatching-matching to a sorting node of a microgrid blockchain corresponding to each of two trading subject parties and update the microgrid blockchain corresponding to each of two trading subject parties after passing the verification;
the trading module is configured to perform an electricity trading based on the trading contract, and record actual trading data on the microgrid blockchain corresponding to each of two trading subject parties.

9. A storage medium, wherein the storage medium stores computer programs for a peer-to-peer electricity trading based on a double-layer blockchain; wherein the computer programs are configured to allow a computer to execute the method for peer-to-peer electricity trading based on a double-layer blockchain of claim 1.

10. An electronic device, comprising:
one or more processors;
a memory; and
one or more programs;
wherein the one or more programs are stored in the memory and configured to be executed by the one or more processors; and the programs comprises the method for peer-to-peer electricity trading based on a double-layer blockchain of claim 1.
